(19) United States
(12) Patent Application Publication
(10) Pub. No.: US 2026/0058189 A1
(43) Pub. Date: Feb. 26, 2026

(54) ELECTRODE, BATTERY AND BATTERY PACK

(71) Applicant: KABUSHIKI KAISHA TOSHIBA, Kawasaki-shi (JP)

(72) Inventors: Masato YANAGI, Yokohama Kanagawa (JP); Naoki NISHIO, Yokohama Kanagawa (JP)

(73) Assignee: KABUSHIKI KAISHA TOSHIBA, Kawasaki-shi (JP)

(21) Appl. No.: 19/372,547

(22) Filed: Oct. 29, 2025

Related U.S. Application Data
(63) Continuation of application No. PCT/JP2024/010554, filed on Mar. 18, 2024.

(51) Int. Cl. H01M 10/0525; H01M 4/02; H01M 4/131; H01M 4/485; H01M 4/505; H01M 4/525; H01M 4/587; H01M 4/62

(52) U.S. Cl. CPC H01M 10/0525; H01M 4/131; H01M 4/485; H01M 4/505; H01M 4/525; H01M 4/587; H01M 4/623; H01M 2004/021; H01M 2004/027; H01M 2004/028

(57) ABSTRACT

According to one embodiment, provide is an electrode including an active material-containing substance, an electro-conductive agent, and a binder. The active material-containing substance contains an active material including a lithium nickel cobalt manganese-containing oxide. A ratio I_{AVE}/I_{TOP} of an average value I_{AVE} of a peak intensity at ±20° C. from a peak top of a highest intensity peak in a m/z=132 curve according to evolved gas analysis-mass spectrometry to a peak top intensity I_{TOP} of the peak top is 0.2 or more and less than 0.5. A ratio A₄₄/A₁₃₂ of an area A₄₄ under a m/z=44 curve within a range of 550° C. to 600° C. according to evolved gas analysis-mass spectrometry to an area A₁₃₂ under the m/z=132 curve within a range of 200° C. to 550° C. is 5 or more and less than 10.

### CROSS REFERENCE TO RELATED APPLICATION

This application is a Continuation Application of PCT Application No. PCT/JP2024/010554, filed Mar. 18, 2024, the entire contents of which are incorporated herein by reference.

### FIELD

Embodiments described herein relate generally to an electrode, battery, and battery pack.

### BACKGROUND

In recent years, an attempt to replace a power source from gasoline to a nonaqueous electrolyte battery such as that for an electric vehicle (EV), a hybrid electric vehicle (HEV) or the like has been made, and in addition, application of the nonaqueous electrolyte battery to a large system for an electric aircraft, power storage or the like is also being anticipated. Therefore, there is a demand for improvement in capacity, large current output performance, and long life performance in a high-temperature environment.

Examples of an active material of the nonaqueous electrolyte battery include lithium nickel cobalt manganese oxide (hereinafter abbreviated as NCM). NCM is, for example, a polycrystalline system in which primary particles having fine particle shapes are aggregated to form secondary particles. However, when such a positive electrode active material having a large specific surface area is used, an oxidation reaction between a positive electrode and an electrolytic solution is likely to occur particularly in charge-and-discharge cycles using a high potential or during storage, and gas generation and an increase in resistance are significant. Furthermore, cracking of positive electrode active material particles, a change to a deteriorated structure such as a rock salt type, or the like occurs during charge-and-discharge cycles, whereby life performance is low.

For example, a spinel type lithium titanate (for example, Li₄Ti₅O₁₂) is used as a negative electrode active material. Since the spinel type lithium titanate reacts at a potential 0.5 V or more higher than a Li reaction potential, precipitation of lithium dendrite can be suppressed. As a result, the spinel type lithium titanate can avoid risks such as short circuit, self-discharge, and ignition, whereby a battery having high safety and excellent life performance can be provided. In addition, increase of a specific surface area of the spinel type lithium titanate allows high output of the battery.

However, an increase in the specific surface area leads to an increase in the amount of moisture that adsorbs onto the negative electrode. The moisture adhered to the negative electrode is electrolyzed by an electrode reaction during battery operation, and hydrogen and oxygen are generated, resulting in an increase in the amount of gas generated. Moreover, the moisture may react with a lithium compound contained in the nonaqueous electrolyte, and lithium fluoride (LiF) may be generated on the negative electrode. Since the presence of LiF on the electrode inhibits insertion of lithium into the electrode active material, the electrical resistance increases.

### BRIEF DESCRIPTION OF THE DRAWINGS

FIG. 1 shows an example of m/z=132 curves according to evolved gas analysis-mass spectrometry.

FIG. 2 shows an example of m/z=44 curves according to evolved gas analysis-mass spectrometry.

FIG. 3 is a plan view schematically showing an example of an electrode according to an embodiment.

FIG. 4 shows a cross-section of an example of a battery according to an embodiment cut along a thickness direction.

FIG. 5 is an enlarged cross-sectional view of section A in FIG. 4.

FIG. 6 is a partially cutaway perspective view of another example of a battery according to the embodiment.

FIG. 7 is an exploded perspective view of an example of a battery pack according to the embodiment.

FIG. 8 is a block diagram showing an electric circuit of the battery pack illustrated in FIG. 7.

### DETAILED DESCRIPTION

According to one embodiment, provided is an electrode including an active material-containing substance, an electro-conductive agent, and a binder. The active material-containing substance contains an active material including a lithium nickel cobalt manganese-containing oxide. A ratio I_{AVE}/I_{TOP} of an average value I_{AVE} of a peak intensity at +20° C. from a peak top of a highest intensity peak in a m/z=132 curve according to evolved gas analysis-mass spectrometry to a peak top intensity I_{TOP} of the peak top is 0.2 or more and less than 0.5. A ratio A₄₄/A₁₃₂ of an area A₄₄ under a m/z=44 curve within a range of 550° C. to 600° C. according to evolved gas analysis-mass spectrometry to an area A₁₃₂ under the m/z=132 curve within a range of 200° C. to 550° C. is 5 or more and less than 10.

According to one embodiment, provided is a battery including a positive electrode including the electrode according to the embodiment, and a negative electrode.

According to one embodiment, provided is a battery pack including the battery according to the embodiment.

The following techniques have been proposed so far. One proposes kneading a positive electrode material containing a positive electrode active material and the like together with water in a process of producing a coating solution, so as to react CO₂ with an alkali compound generated by a reaction between the positive electrode active material and water to thereby generate carbonates on a surface of the positive electrode material, so that contact between a carbon material and an electrolytic solution is suppressed whereby a decomposition reaction of an electrolytic solution is suppressed. In addition, it has been reported that adhesiveness of an electrode material is improved by adding an organic material having a high alkalinity to the electrode. Moreover, it has been reported that output at low temperature is increased through reduction of reaction resistance by removal of LiOH and Li₂CO₃ on a surface of the positive electrode active material by addition of acetic anhydride as an acid to a positive electrode mixture paste using a positive electrode active material containing a certain amount of LiOH. Furthermore, it has been reported that by adding a dispersant to a slurry composition for an electrochemical device electrode, a slurry composition having excellent temporal stability of the dispersed state can be prepared, and rate characteristics and high-temperature storage characteristics of the resulting electrochemical device can be enhanced. In addition, it has been reported that an electrode provided with an electrode mixture layer containing an electrically conductive material including carbon nanotubes and a dispersant can enhance cycle characteristics, rate characteristics, and high-temperature storage characteristics of an electrochemical device.

As a result of intensive studies, the present inventors have found that when a binder is excessively bound to an electro-conductive agent, binding of the binder to an active material decreases, resulting in a decrease in life performance. When the binder is excessively bound to the electro-conductive agent, dispersibility of the electro-conductive agent decreases, and the electro-conductive agent aggregates, causing current unevenness within the electrode at the time of charging and discharging, leading to a decrease in life performance. In addition, since binding of the binder to the active material decreases, an influence of volume expansion and contraction of the active material at the time of charging and discharging cannot be suppressed, thus being a factor causing peeling of an electrode mixture layer from a current collector or cracking of an electrode. Based on the above findings, it has been found that by suppressing excessive binding between the electro-conductive agent and the binder, and uniformly dispersing the active material, the electro-conductive agent, and the binder in the electrode, the life performance is improved.

### First Embodiment

According to a first embodiment, an electrode is provided. The electrode includes an active material-containing substance that contains an active material including a lithium nickel cobalt manganese-containing oxide, an electro-conductive agent, and a binder. In a thermograph according to evolved gas analysis-mass spectrometry for the electrode, a ratio I_{AVE}/I_{TOP} of an average value I_{AVE} of a peak intensity within a range 20° C. on both sides of a peak top of a highest intensity peak in a m/z=132 curve relative to a peak top intensity I_{TOP} of the peak top is 0.2 or more and less than 0.5. Moreover, a ratio A₄₄/A₁₃₂ of an area A₄₄ under a m/z=44 curve within a range of 550° C. to 600° C. relative to an area A₁₃₂ under the m/z=132 curve within a range of 200° C. to 550° C. is 5 or more and less than 10 in a thermograph according to evolved gas analysis-mass spectrometry for the electrode.

Each of the above-described ratios for the m/z=132 curve and the m/z=44 curve according to evolved gas analysis-mass spectrometry (EGA-MS) is an index of the degree of binding of the binder to the active material or the electro-conductive agent. Specifically, in the m/z=44 curve, the magnitude of the peak at 550° C. or higher indicates the amount of binding between the active material and the binder, and in the m/z=132 curve, the kurtosis of the peak having the highest intensity indicates the degree of binding between the electro-conductive agent and the binder. In the electrode in which the highest intensity peak in the m/z=132 curve has a kurtosis having the ratio I_{AVE}/I_{TOP} of 0.2 or more and less than 0.5, and the ratio A₄₄/A₁₃₂ of the areas under the m/z=132 curve and the m/z=44 curve is 5 or more and less than 10, the electro-conductive agent is well dispersed, and the binder is appropriately bound to the active material. Thus, excellent life performance is exhibited.

Specifically, binding between the electro-conductive agent and the binder is suppressed, and aggregation of the electro-conductive agent is reduced. The suppression of the binding between the electro-conductive agent and the binder also leads to promotion of the binding of the binder to the active material, and the electrode is uniformized. When the binder is uniformly dispersed with the active material and with the electro-conductive agent, current unevenness during charge-and-discharge is reduced. Therefore, local deterioration in the electrode is reduced and an increase in resistance is reduced. Accordingly, the capacity can be maintained even when charge-and-discharge cycles are repeated, and so the life performance is high. The life performance is also high by virtue of cutting of electrically conductive paths due to expansion and contraction of the active material associated with charge-and-discharge being suppressed through an appropriately large amount of the binder being bound to the active material. Furthermore, excellent life performance is also achieved by virtue of the active material surface in contact with the electrolyte being small, which reduces the generation of gas due to the reaction between the electrolyte and the active material.

In other words, dispersibility of the electro-conductive agent and coatability of the binder on the active material in the electrode can be evaluated according to EGA-MS analysis.

The dispersibility of the electro-conductive agent can be estimated by referring to a curve derived from a component detected as m/z=132 in a thermogram obtained when the electrode is subjected to EGA-MS analysis. The curve of m/z=132 can be attributed to trifluorobenzene. A typical example of the binder is polyvinylidene fluoride (PVdF). When PVdF is heated, a polymer chain is broken, and therefore PVdF is detected as trifluorobenzene according to EGA-MS. Thus, the m/z=132 curve shows transition of decomposition of PVdF. When PVdF comes into contact with the electro-conductive agent in the electrode, the decomposition temperature is shifted to the low temperature side due to a catalytic action, and the peak having the highest intensity in the m/z=132 curve is broadened. Therefore, the kurtosis of the highest intensity peak of the m/z=132 curve is an index of dispersibility of the electro-conductive agent.

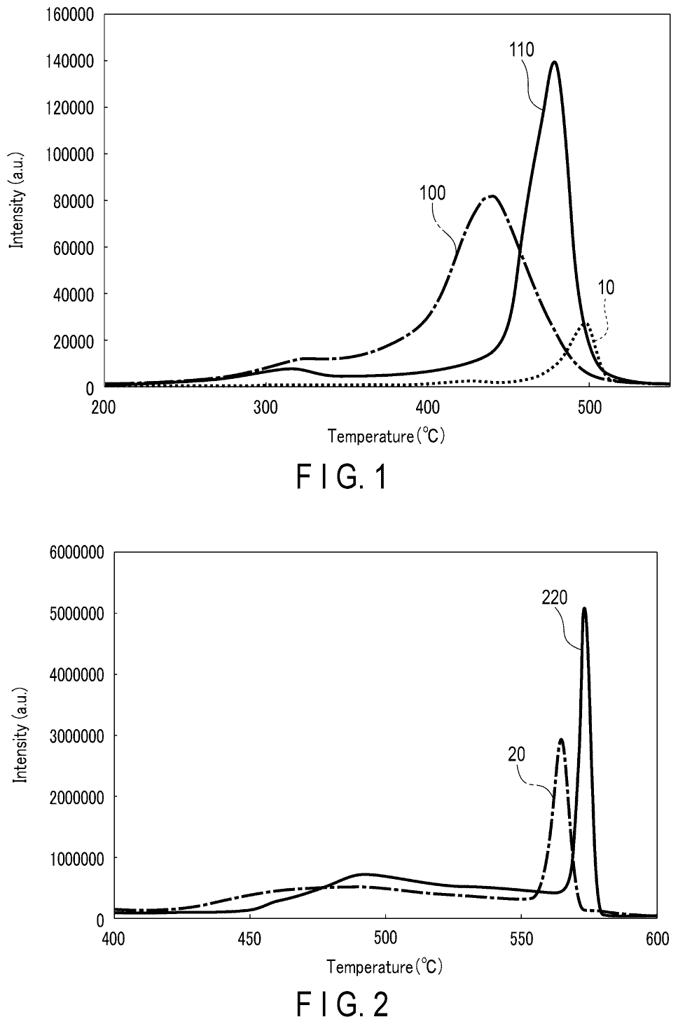

An example of the m/z=132 curve is shown in FIG. 1. FIG. 1 is an example of the curve of m/z=132 according to EGA-MS. A curve 10 indicated by a dotted line was obtained by using PVdF alone as the sample. A curve 100 indicated by a dotted-dashed line was obtained by using, as the sample, the electrode in which the dispersibility of the electro-conductive agent was low and a large amount of the PVdF binder was bound to the electro-conductive agent. Since the amount of PVdF in contact with the electro-conductive agent serving as a catalyst was large, the peak top position is shifted toward the lower temperature side as compared with the case of PVdF alone (curve 10), and the peak is broadened. A curve 110 indicated by a solid line was obtained by using, as the sample, the electrode in which the dispersibility of the electro-conductive agent was increased to thereby decrease the binding of PVdF to the electro-conductive agent. As shown in the figure, the highest intensity peak of the curve 110 is sharper with less shift to the lower temperature side, and is closer in position and shape to the peak of curve 10 obtained by using the sample of PVdF alone.

In the thermogram obtained when the electrode is subjected to EGA-MS analysis, the degree of coating of the binder onto the active material can be estimated by referring to a curve derived from a component detected as m/z=44. The m/z=44 curve may include a peak attributed to carbon dioxide (CO₂). In the m/z=44 curve, the peak appearing at 550° C. or higher is derived from carbon dioxide (CO₂) generated by decomposition of the binder such as PVdF bound to the active material. The higher the intensity of the peak, the more the binder was bound to the active material.

An example of the m/z=44 curve is shown in FIG. 2. FIG. 2 shows an example of a curve of m/z=44 according to EGA-MS. A curve 20 indicated by a dotted-dashed line was obtained by using, as the sample, the electrode in which the dispersibility of the electro-conductive agent was low and a large amount of the PVdF binder was bound to the electro-conductive agent. Since the amount of PVdF bound to the electro-conductive agent was large, the amount of PVdF bound to the active material was small. A curve 220 indicated by a solid line was obtained using, as the sample, the electrode in which the dispersibility of the electro-conductive agent was increased to thereby decrease the binding of PVdF to the electro-conductive agent. While PVdF bound to the electro-conductive agent was decreased, PVdF bound to the active material was increased. For the intensity of the peak present at 550° C. or higher, the curve 220 obtained by using the sample with a large amount of PVdF bound to the active material has a higher intensity than the curve 20 obtained by using the sample with a small amount of PVdF bound to the active material.

Hereinafter, the electrode of the embodiment will be described in detail. The electrode of the embodiment may be a negative electrode or a positive electrode.

The electrode includes, for example, a mixture layer and a current collector onto which the mixture layer is stacked. The mixture layer contains an active material-containing substance, an electro-conductive agent, and a binder.

The active material-containing substance at least contains a lithium nickel cobalt manganese-containing oxide as an active material (referred to as first active material). Examples of the lithium nickel cobalt manganese-containing oxide include lithium nickel cobalt manganate. The lithium nickel cobalt manganese-containing oxide is represented by, for example, LiₐNi_{(1-b-c-d)}Co_{b}Mn_{c}M_{d}O₂. In the above formula, 1≤a≤1.2, 0<b≤0.4, 0<c≤0.4, —0≤d≤0.1, and M is one or more elements selected from the group consisting of Fe, Cu, Ti, Mg, Al, W, Y, B, Mo, Nb, Zn, Sn, Zr, Ga, and V.

The lithium nickel cobalt manganese-containing oxide represented by the above formula has a large capacity per unit weight, and a large capacity can be obtained by using it up to an electrode potential of 4.2 V (vs. Li/Li⁺) or more. A molar ratio a in the formula may vary when the electrode has lithium ions inserted therein and extracted therefrom. A more preferable range is 1.05≤a≤1.15.

With a molar ratio b in the formula set to 0<b≤0.4 and a molar ratio c set to 0<c≤0.4, the lithium nickel cobalt manganese-containing oxide further contains Co and Mn in addition to Ni as transition metals, so that the capacity per unit weight increases. More preferable ranges of the molar ratio b and the molar ratio c are 0.05≤b≤0.2 and 0.05≤c≤0.2, respectively.

A more preferable range of a molar ratio d of the element M in the formula is 0.01≤d≤0.05. The inclusion of the element M, for example, can provide the following effects. Since Al can reduce lattice distortion, Li ion diffusibility can be improved. Mg can improve electron conductivity of bulk, and thus can improve an apparent discharge capacity. Furthermore, cycle stability under high voltage can be improved. Zr can improve cycle performance. Ti can improve the cycle performance by alleviating phase change that takes place under high-voltage charge and discharge. Ga can improve the electron conductivity of the bulk, and thus can improve the cycle performance.

The lithium nickel cobalt manganese-containing oxide may contain other species of elements other those described above as an inevitable impurity.

The lithium nickel cobalt manganese-containing oxide may have a particle shape. Examples of particles of the lithium nickel cobalt manganese-containing oxide include single-particles (alternatively referred to as singular primary particles, as well), and secondary particles (alternatively referred to as polycrystals, as well) in which the primary particles are aggregated. A mixture of single-particles and secondary particles may be used, as well. Although the polycrystalline lithium nickel cobalt manganese-containing oxide can have an increased specific surface area, the oxidation reaction of the electrolyte easily occurs during charge-and-discharge cycles or a calender test at a high potential, and hence, gas generation and resistance increase are greater than those in the case of single-particles. In addition, cracking of the active material particles, a change into a degraded structure such as a rock salt type, and the like may occur during the cycle. Since the single-particles of the lithium nickel cobalt manganese-containing oxide are less apt to crack as compared to the secondary particles, exposure of new surfaces due to cracking can be suppressed. By suppressing the exposure of new surfaces, an increase in reactions between the electrolyte and the active material can be suppressed.

The active material-containing substance may contain another active material (second active material) other than the lithium nickel cobalt manganese-containing oxide. The second active material may include various oxides, for example, a lithium-containing cobalt oxide (for example, LiCoO₂), manganese dioxide, lithium-manganese composite oxide (for example, LiMn₂O₄ and LiMnO₂), lithium-containing nickel oxide (for example, LiNiO₂), lithium-containing nickel cobalt oxide (for example, LiNi_{0.8}Co_{0.2}O₂), lithium-containing iron oxide, lithium-containing vanadium oxide, and chalcogen compounds such as titanium disulfide and molybdenum disulfide. The species of the active material used may be one species or two species or more.

The particles of the active material containing the lithium nickel cobalt manganese-containing oxide are desirably occupied by the single-particles in a higher proportion than the secondary particles. This can suppress cracking of the active material particles. Active material particles having a breaking strength of 30 MPa or more and 300 MPa or less can be suppressed from cracking, so that an increase in reactions between the electrolyte and the active material can be suppressed. A more preferable range of the breaking strength is 120 MPa or more and 300 MPa or less.

The active material containing the lithium nickel cobalt manganese-containing oxide can have a ratio D₉₀/D₁₀ of 4 or less in a volume-based cumulative frequency distribution of particle sizes based on a particle size distribution according to a laser diffraction scattering method. The particle size distribution is a volume-based cumulative frequency distribution that is accumulated from a smaller particle size side of the active material. D₁₀ is a particle size at which a cumulative frequency from a smaller particle size side of the cumulative frequency distribution is 10%. D₉₀ is a particle size at which the cumulative frequency from the smaller particle size side of the cumulative frequency distribution is 90%. The particle size distribution having a ratio D₉₀/D₁₀ of 4 or less is sharp and is highly monodisperse. Therefore, an active material having a particle size distribution in which the ratio D₉₀/D₁₀ is 4 or less can be suppressed from cracking, so that an increase in alkali component can be suppressed. The ratio D₉₀/D₁₀ is an index indicating a variation in particle size, and the smaller the value, the smaller the variation. The ratio D₉₀/D₁₀ is 1 when all the particles have the same particle size.

The particles of the active material containing the lithium nickel cobalt manganese-containing oxide can have an average particle size D₅₀ according to a laser diffraction scattering method of 2 μm or more and 8 μm or less. D₅₀ is a particle size at which the cumulative frequency from the smaller particle size side of the cumulative frequency distribution is 50%.

A content of the first active material (lithium nickel cobalt manganese-containing oxide) in the active material comprising-substance may be in a range of 50 mass % or more and 99.6 mass % or less.

The active material-containing substance preferably contains 0.4 mass % or more and 1 mass % or less of an alkali component. The alkali component contains at least one of lithium carbonate (Li₂CO₃) or lithium hydroxide (LiOH). The alkali component may be derived from, for example, a raw material used in synthesizing the lithium nickel cobalt manganese-containing oxide. The alkali component may be residual alkali upon active material synthesis.

The binding amount of the binder to the active material has a correlation with the alkali component contained in the active material comprising-substance. In order to appropriately adjust the amount of the binder that is bound to the active material, an appropriate amount of the alkali component is desirably contained in the active material-containing substance. If the content of the alkali component in the active material-containing substance is 0.4 mass % or more, the binding amount of the binder to the active material is not deficient. Then, due to a polyene formation reaction of the binder, a cross-linking reaction of the binder proceeds, and the binding force between the mixture layer and the current collector is increased. Due to the increase in the binding force, the mixture layer can be maintained on the current collector during the charge-and-discharge cycle. Thus, electrically conductive paths within the electrode is less likely to be impaired, and deterioration unevenness does not occur in the electrode. Therefore, the resistance increase rate is suppressed to be small and the life performance is improved. Furthermore, because the binder is bound to the active material, the surface on which the electrolyte can be in contact with the active material is decreased, and generation of gas such as hydrogen fluoride (HF) caused by a side reaction between the electrolyte and the active material can be thus suppressed. When the content of the alkali component in the active material-containing substance is 1 mass % or less, the binding amount of the binder to the active material does not become excessive. Then, a progress of the polyene formation reaction of the binder is appropriately suppressed, and acceleration of the cross-linking reaction of the binder is restrained to a certain level. Thereby, an increase in resistance due to the active material being covered with the binder can be suppressed while the binding force between the mixture layer and the current collector is increased. Therefore, the resistance increase rate is reduced, and the life performance is improved. The more preferable range of the content of the alkali component in the active material-containing substance is 0.5 mass % to 0.7 mass %.

The alkali component is, for example, adhered to or deposited onto the active material particles in a solid state. More specifically, the alkali component may be adhered to or deposited onto the surface of the active material particle to a grain boundary of the active material particle, in a solid state.

The binder may include, as a first binder, polyvinylidene fluoride (PVdF) and derivatives thereof. A derivative of PVdF may be, for example, PVdF having a COOZ group. Here, Z includes at least one element amongst H and Li. The COOZ group may be bound to a main chain or a side chain of PVdF. Alternatively, a derivative of PVdF may be, for example, PVdF having a COOX group. The COOX group is a carboxylate group. An example of X is Li. The COOX group may be generated by a reaction of the COOH group with the active material. For example, it is presumed that when the active material-containing substance contains an alkali component, a polyene formation reaction of PVdF having a COOH group proceeds due to the alkali component, and the COOH group (carboxy group) is modified to a COOX group (carboxylate group).

A content of the first binder in the mixture layer may, for example, be in a range of 0.5 mass % or more and 5 mass % or less.

The binder may contain a binder (referred to as second binder) other than the first binder. Examples of the second binder include polytetrafluoroethylene (PTFE), fluororubber, styrene-butadiene rubber (SBR), carboxymethyl cellulose (CMC), polyimide, and polyamide. The species of the binder may be one species or two species or more.

As the electro-conductive agent, for example, a carbon material may be used. Specific examples include carbon black such as acetylene black and Ketjen black, graphite, carbon fiber, carbon nanotube, and fullerene. The species of the electro-conductive agent may be one species or two species or more.

Blending proportions of the active material-containing substance, the electro-conductive agent, and the binder in the mixture layer are preferably 75 mass % or more and 96 mass % or less for the active material-containing substance, 3 mass % or more and 20 mass % or less for the electro-conductive agent, and 1 mass % or more and 5 mass % or less for the binder.

A density of the mixture layer may, for example, be 3.1 g/cm³ or more and 3.5 g/cm³ or less.

The electrode may further include, in the mixture layer, a polymer having a functional group that adsorbs onto the electro-conductive agent. The polymer may be added as a dispersant for improving the dispersibility of the electro-conductive agent during production of the electrode. Examples thereof include a polymer containing a nitrogen-containing monomer. Specific examples thereof include a polymer that can be used as a dispersant, described below.

The polymer may be contained in the mixture layer in an amount of, for example, 2% or more, 3% or more, or 5% or more in terms of mass ratio with respect to the electro-conductive agent. The polymer may be contained in the mixture layer in an amount of, for example, 20% or less, 15% or less, or 10% or less in terms of mass ratio with respect to the electro-conductive agent.

The current collector is preferably an aluminum foil or an aluminum alloy foil, and an average crystal grain size thereof is preferably 50 μm or less, more preferably 30 μm or less, and even more preferably 5 μm or less. The current collector made of the aluminum foil or aluminum alloy foil having such an average crystal grain size can dramatically increase the strength, can densify the electrode at a high press pressure, and can increase the battery capacity.

A thickness of the current collector is preferably 20 μm or less, and more preferably 15 μm or less. A purity of the aluminum foil is preferably 99% or more. The aluminum alloy is preferably an alloy containing an element such as magnesium, zinc, or silicon. On the other hand, a content of a transition metal such as iron, copper, nickel, or chromium is preferably 1% or less.

The electrode is produced by, for example, suspending the active material-containing substance, electro-conductive agent, binder, and dispersant in an appropriate solvent, applying the obtained slurry onto a current collector and drying to produce a mixture layer, and then pressing the mixture layer. Otherwise, the active material-containing substance, electro-conductive agent, binder, and dispersant may be formed into pellets and used as a mixture layer.

The active material-containing substance can be synthesized by, for example, a solid phase reaction method or a coprecipitation method.

According to a solid phase reaction method, powder raw materials of a nickel oxide, cobalt oxide, manganese oxide, and lithium oxide (LiOH, Li₂CO₃, etc.) are weighed and mixed so as to have a predetermined composition, and then heat-treated at a high temperature, thereby obtaining an active material-containing substance that contains a lithium nickel cobalt manganese-containing oxide (first compound).

According to a coprecipitation method, an active material-containing substance that contains a lithium nickel cobalt manganese-containing oxide (first compound) can be obtained as follows. A solution containing a nickel salt, cobalt salt, and manganese salt is prepared, an acidity of the uniformly stirred solution is adjusted to be basic, and deposition/precipitation is thus caused, to thereby obtain a first precursor. Then, the first precursor is washed and mixed with a lithium salt (LiOH, Li₂CO₃, or the like), to thereby obtain a second precursor. The second precursor is heat-treated at a high temperature, to thereby obtain a target product.

At the time of the synthesis, by changing the amount of the lithium salt (LiOH, Li₂CO₃, or the like) used as a raw material and the composition ratio of Ni, Co, and Mn, an amount of residual alkali component can be appropriately adjusted in the obtained active material comprising-substance. Furthermore, by washing the active material comprising-substance with water, the amount of the alkali component can be reduced. By appropriately adjusting the amount of the alkali component in this manner, the binder can be subjected to an appropriate cross-linking reaction to control the coatability onto the active material.

The dispersant for improving the dispersion of the electro-conductive agent is not particularly limited as long as the dispersant has a functional group for adsorbing to the electro-conductive agent. The dispersant may be, for example, a polymer containing a nitrogen-containing monomer. Among them, a dispersant capable of adsorbing well onto a carbon material-based electro-conductive agent such as carbon black is desirable.

Specific examples of the dispersant include a polymer containing a nitrile group-containing monomer unit and an alkylene structural unit. The nitrile group-containing monomer unit may be formed using one or more α,β-ethylenically unsaturated nitrile monomers. Examples of the α,β-ethylenically unsaturated nitrile monomer include acrylonitrile, α-halogenoacrylonitrile such as α-chloroacrylonitrile and α-bromoacrylonitrile, methacrylonitrile, α-alkylacrylonitrile such as α-ethylacrylonitrile, and the like. The alkylene structural unit refers to a repeating unit composed only of an alkylene structure represented by —CₙH₂ₙ—. The subscript n in the above formula is an integer of 2 or more.

Other specific examples of the dispersant include a polymer including a structural unit represented by the following structural formula (1). The structural unit allows adsorption onto the surface of the electro-conductive agent. The polymer may be a copolymer including the structural unit represented by the following structural formula (1) and other structural units.

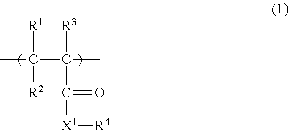

In the structural formula (1), R¹, R², and R³ are one or more selected from the group consisting of a hydrogen atom, a methyl group, and an ethyl group. R¹, R², and R³ may be the same as or different from each other. X¹ is an oxygen atom or NH. R⁴ is a hydrocarbyl group having 8 to 30 carbon atoms.

From the viewpoint of improvement of the dispersibility of the electro-conductive agent, R¹ and R² are preferably hydrogen atoms. R³ is preferably a hydrogen atom or a methyl atom. R³ is more preferably a methyl atom. R⁴ is preferably an alkyl group or an alkenyl group. The number of carbon atoms of R⁴ is preferably 12 or more, and more preferably 16 or more. The number of carbon atoms of R⁴ is preferably 24 or less, and more preferably 22 or less. As R⁴, more specific examples include an octyl group, a 2-ethylhexyl group, a decyl group, a lauryl group, a myristyl group, a cetyl group, a stearyl group, an oleyl group, and a behenyl group.

In synthesizing the polymer, examples of monomers that provide the above-indicated structural unit include an ester compound and an amide compound. Specific examples of the ester compound include 2-ethylhexyl (meth)acrylate, octyl (meth)acrylate, lauryl (meth)acrylate, stearyl (meth)acrylate, isostearyl (meth)acrylate, behenyl (meth)acrylate, and the like. Specific examples of the amide compound include 2-ethylhexyl (meth)acrylamide, octyl (meth)acrylamide, lauryl (meth)acrylamide, stearyl (meth)acrylamide, behenyl (meth)acrylamide, and the like.

Other specific examples of the dispersant include a polymer containing 2-(meth)acrylamide-2-methylpropane sulfonic acid (salt) as a constituent monomer. The “2-(meth)acrylamido-2-methylpropane sulfonic acid (salt)” includes a 2-(meth)acrylamido-2-methylpropane sulfonic acid and salts thereof. The 2-(meth)acrylamide-2-methylpropane sulfonic acid salt includes a salt of 2-(meth)acrylamide-2-methylpropane sulfonic acid and an inorganic base, and a salt of 2-(meth)acrylamide-2-methylpropane sulfonic acid and an organic base. Examples of the inorganic base include ammonia, a metal hydroxide, and an alkali metal carbonate. Examples of the organic base include mono- to tri-alkyl amine having an alkyl group with 1 to 8 carbon atoms. The polymer may be a copolymer containing other constituent monomers together with the 2-(meth)acrylamide-2-methylpropane sulfonic acid (salt).

The amount of the dispersant added to the slurry is, for example, 2% or more in terms of a mass ratio to the electro-conductive agent. The addition amount of the dispersant is preferably 3% or more, and more preferably 5% or more (mass ratio to the electro-conductive agent). The addition amount of the dispersant is, for example, 20% or less in terms of mass ratio with respect to the electro-conductive agent. The addition amount of the dispersant is preferably 15% or less, and more preferably 10% or less (mass ratio to the electro-conductive agent). By appropriately increasing the addition amount of the dispersant, the dispersant is bonded to the electro-conductive agent to promote dispersion and the binding between the binder and the electro-conductive agent decreases, leading to a decrease in aggregation of the electro-conductive agent. Since the reaction unevenness due to the aggregate of the electro-conductive agent is less likely to occur, local deterioration of the electrode is suppressed, thereby improving the life performance. Since the dispersant is an organic component as described above, the dispersant may become a resistance component in the electrode. Therefore excessive addition of the dispersant is not desirable. By appropriately adjusting the addition amount of the dispersant, the binder in the electrode is less likely to be bound to the electro-conductive agent, and the aggregate of the electro-conductive agent is less likely to occur, achieving uniform dispersion in the electrode. Therefore, the cycle life performance of the battery using the electrode can be improved.

As described above, by appropriately controlling the amount of the alkali component contained in the active material-containing substance and adding the appropriate amount of the dispersant for improving the dispersibility of the electro-conductive agent, the electro-conductive agent can be uniformly dispersed while suppressing excessive binding between the electro-conductive agent and the binder, whereby the binding of the binder to the active substance can be promoted. In other words, the ratio I_{AVE}/I_{TOP} representing the peak kurtosis in the m/z=132 curve of the EGA thermogram and the above-described area ratio A₄₄/A₁₃₂ between the m/z=44 curve and the m/z=132 curve can be controlled by the addition amount of the dispersant and the residual alkali amount contained in the active material-containing substance.

When the amount of the dispersant is increased, the binding between the electro-conductive agent and the dispersant increases, whereby the contact between the electro-conductive agent and the binder is suppressed, so the dispersibility of the electro-conductive agent tends to be enhanced. Since there is a decrease in the catalytic action of the electro-conductive agent that lowers the decomposition temperature of the binder, the shift of the highest intensity peak of the m/z=132 curve to the low temperature side is reduced, and the peak is sharper, making the kurtosis become closer to the kurtosis of the peak obtained by the binder alone. On the contrary, when the amount of the dispersant is decreased, the dispersibility of the electro-conductive agent is decreased, whereby its binding with the binder tends to be increased. Since the decomposition temperature of the binder is lowered by the catalytic action of the electro-conductive agent, the highest intensity peak of the m/z=132 curve shifts further toward the lower temperature side and becomes broader. Thus, a larger amount of the dispersant decreases the ratio LAVE/I_{TOP}, and a smaller amount of the dispersant increases the ratio I_{AVE}/I_{TOP}. By appropriately adjusting the addition amount of the dispersant, the dispersibility of the electro-conductive agent can be controlled.

When the amount of the residual alkali contained in the active material comprising-substance increases, binding of the binder to the active material tends to be enhanced. Since CO₂ generated by decomposition of the binder on the active material according to EGA-MS analysis increases, the area of the m/z=44 curve increases. On the other hand, when the amount of the residual alkali contained in the active material comprising-substance is small, CO₂ generated by the decomposition of the binder according to EGA-MS analysis decreases, and the area of the m/z=44 curve decreases. Therefore, when the amount of the alkali component contained in the active material-containing substance is large, the area ratio A₄₄/A₁₃₂ increases, and when the amount of the alkali component is small, the area ratio A₄₄/A₁₃₂ decreases. By appropriately adjusting the amount of the alkali component, the coatability of the binder onto the active material can be controlled.

As indicated by the peak kurtosis of the m/z=132 curve described above, when the electro-conductive agent is well dispersed, the charge-discharge reaction within the electrode is uniform, and the cycle life performance of the battery is excellent. As indicated by the area ratio between the m/z=44 curve and the m/z=132 curve described above, when the active material is coated with an appropriate amount of the binder, the influence of expansion and contraction of the active material associated with charging and discharging is suppressed, and the elution of the alkali component on the surface of the active material is suppressed, whereby generation of hydrogen fluoride is suppressed. Therefore, gas generation and capacity decrease associated with charge-and-discharge cycles are reduced, and the cycle life performance of the battery is excellent.

Next, a specific example of the electrode according to the first embodiment will be described with reference to the drawings.

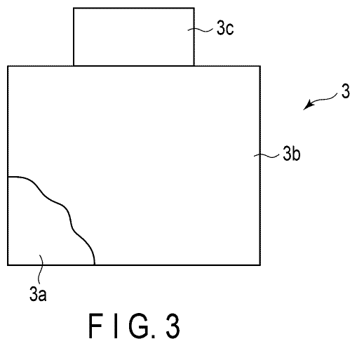

FIG. 3 is a partially cutaway plan view schematically illustrating an example of the electrode according to the embodiment. An example of a positive electrode is illustrated as an example of the electrode.

A positive electrode 3 illustrated in FIG. 3 includes a positive electrode current collector 3a and a positive electrode active material-containing layer 3b as a mixture layer provided on a surface of the positive electrode current collector 3a. The positive electrode active material-containing layer 3b is supported on a principal surface of the positive electrode current collector 3a.

In addition, the positive electrode current collector 3a includes a portion where the positive electrode active material-containing layer 3b is not provided on the surface thereof. This portion serves as a positive electrode current collecting tab 3c. In the illustrated example, the positive electrode current collecting tab 3c is a narrow portion having a width narrower than that of the positive electrode active material-containing layer 3b. The width of the positive electrode current collecting tab 3c may be narrower than the width of the positive electrode active material-containing layer 3b as described above, or may be the same as the width of the positive electrode active material-containing layer 3b. Instead of the positive electrode current collecting tab 3c which is a part of the positive electrode current collector 3a, a separate electrically conductive member may be electrically connected to the positive electrode 3 and used as an electrode current collecting tab (positive electrode current collecting tab).

Methods for measuring the active material composition, each m/z value curve according to evolved gas analysis-mass spectrometry, the alkali component, the breaking strength, the average particle size, and the ratio D₉₀/D₁₀ in the electrode of the embodiment, will be respectively described below.

When the electrode to be measured is incorporated in a battery, the electrode as measurement sample is taken out from the battery as follows. The battery is discharged, and disassembled in a glove box in an argon atmosphere, and the electrode is taken out. The electrode is washed with ethyl methyl carbonate and then vacuum-dried. In this way, the measurement sample is obtained.

### (Examination of Active Material Composition)

The composition of the active material can be examined by measuring the surface of the electrode by X-ray fluorescence (XRF).

### (Evolved Gas Analysis-Mass Spectrometry)

Measurement of an electrode according to evolved gas analysis-mass spectrometry (EGA-MS) is carried out as follows.

As a sample, a mixture layer scraped off from the electrode is used. Specifically, approximately 10 mg of a mixture layer is scraped off from the electrode as an sample. As a measurement device, the multi-shot pyrolyzer (EGA/PY-3030D) manufactured by Frontier Laboratories Ltd. and the gas chromatography mass spectrometer 7890A/5975C manufactured by Agilent Technologies, Inc. are used in combination. A sample scraped off from the electrode is set in a sample cup and subjected to EGA-MS measurement. The atmosphere during measurement is not particularly limited as long as a non-oxidizing atmosphere is adopted. For example, an inert gas atmosphere of helium, argon, nitrogen, and the like can be used. The EGA-MS measurement is carried out in a temperature range of 40° C. to 600° C. at a heating rate of 10° C./min.

The resulting EGA thermogram is analyzed, and the curve derived from the component of m/z=44 and the curve derived from the component of m/z=132 respectively belonging to carbon dioxide and trifluorobenzene are separated. In the curve of m/z=132, the peak having the highest intensity is analyzed, the intensity I_{TOP} of the peak top thereof and the average value LAVE of the peak intensities before and after the peak top are obtained, and the ratio I_{AVE}/I_{TOP} is calculated. An area A₁₃₂ under the m/z=132 curve in the range of 200° C. to 550° C. and an area A₄₄ under the m/z=44 curve in the range of 550° C. to 600° C. are obtained, and the ratio A₄₄/A₁₃₂ is calculated. (Examination of Alkali Component)

Whether or not lithium carbonate (Li₂CO₃) is contained in the alkali component is examined by the following method. As a sample, a mixture layer cut out from the electrode is used. Specifically, a mixture layer having an area of 500 cm² is cut out from the electrode as the sample. A mass of the active material-containing substance in the mixture layer as the sample is determined from the area of 500 cm² of the mixture layer and a basis weight (g/m²) of the mixture layer.

As an instrument, an AGK type CO₂ simple and precise quantifier manufactured by TSUTSUI RIKAGAKU KIKAI K.K. is used. About 50 ml of water is added to the sample cut out from the electrode by the above method, a solution obtained by mixing sulfuric acid and water at a volume ratio of 1:5 is then added for neutralization, and a small excess is further added. Then the solution is boiled to separate CO₂ together with water vapor. When these are absorbed into an aqueous BaCl₂ solution in which a known amount of NaOH coexists, a reaction shown in reaction formula (2) below occurs.

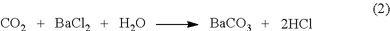

Then, as shown in Reaction Formula (3) below, remaining NaOH is quantified by neutralization titration, and Li₂CO₃ is calculated by converting consumed NaOH.

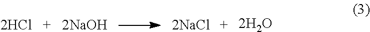

Whether or not lithium hydroxide (LiOH) is contained in the alkali component is examined by the following method.

To 10 g of the sample cut out from the electrode by the above method, 50 ml of water is added, followed by stirring with a magnetic stirrer for 1 hour. After filtration, a total volume of 15 ml of the filtrate is collected with a pipette, and 20 ml of a 1% barium chloride solution is added thereto. While measuring the pH, titration is performed with hydrochloric acid at a concentration of 0.05 mol/L until the pH becomes less than 8.4, and the titration amount is converted into LiOH.

### (Measurement of Content of Alkali Component in Active Material-Containing Substance)

A mixture layer having an area of 500 cm² is cut out as a sample from the electrode. The sample is added to water and subjected to stirring for 10 minutes, then assuming lithium compound present in the water as an alkali component in the active material-containing substance, the pH thereof is titrated with an acid to determine the mass of the alkali component, and a mass proportion (mass %) of the alkali component relative to the active material comprising-substance is determined. Mass of the active material comprising-substance in the mixture layer as the sample is determined from the area of 500 cm² of the mixture layer and a basis weight (g/m²) of the mixture layer. The species of the alkali component is specified by the above-mentioned method.

### (Method for Measuring Breaking Strength)

The electrode is immersed in an N-methyl-2-pyrrolidone solution and subjected to stirring to peel off the mixture layer from the current collector. From the peeled mixture layer, components having a size of 2 μm to 6 μm are selected, and an extremely small amount thereof is scattered on a pressure plate, then compressed one by one per particle using a Shimadzu micro compression tester MCT-510. The breaking strength is calculated by the following formula.

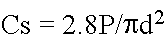

Here, Cs represents a breaking strength (numerical unit: N/mm² or MPa), P represents a test force (numerical unit: N), and d represents a particle size (numerical unit: mm). Whether the mixture layer components having a size of 2 μm to 6 μm are lithium nickel cobalt manganese-containing oxides or not can be examined by performing elemental analysis such as Inductively-Coupled Plasma (ICP) emission spectrometry on this sample.

### (Method for Measuring Average Particle Size)

The particle size distribution of the electrode can be measured by a laser diffraction/scattering method which will be described below. In the electrode washed and dried by the above method, the active material-containing layer is separated from the current collector using, for example, a spatula to obtain a powdery electrode mixture sample containing active material particles. Then, the powdery sample is charged into a measurement cell filled with N-methylpyrrolidone (NMP) until the concentration reaches a measurable concentration. The capacity of the measurement cell and the measurable concentration differ depending on the particle size distribution measuring apparatus. The measurement cell containing NMP and the electrode mixture sample dissolved therein is irradiated with ultrasonic waves for 5 minutes. The output of ultrasonic wave is set, for example, in a range of 35 W to 45 W. For example, when NMP is used as the solvent in an amount of about 50 ml, the solvent mixed with the measurement sample is irradiated with ultrasonic waves having an output of about 40 W for 300 seconds. By such ultrasonic irradiation, the aggregation between the electro-conductive agent particles and the active material particles can be resolved. The measurement cell is inserted into a particle size distribution measuring apparatus by the laser diffraction scattering method, and the particle size distribution is measured. Examples of the particle size distribution measuring apparatus include Microtrac3100 and Microtrac3000II (both manufactured by MicrotracBEL Corp.), or an apparatus having a function equivalent thereto. Thus, the particle size distribution of the electrode can be obtained.

(Method for Calculating Ratio D₉₀/D₁₀)

The particle size distribution obtained by the above method is a volume-based cumulative frequency distribution that is accumulated in order from a smaller particle size side. In the particle size distribution, the particle size D₁₀ at which the volume-based cumulative frequency from the smaller particle size side is 10% and the particle size D₉₀ at which the volume-based cumulative frequency from the smaller particle size side is 90% are determined. The ratio D₉₀/D₁₀ is calculated from the obtained values.

The electrode according to the first embodiment includes an active material-containing substance that contains an active material including a lithium nickel cobalt manganese-containing oxide, an electro-conductive agent, and a binder. The above-mentioned ratio I_{AVE}/I_{TOP} is 0.2 or more and less than 0.5 and the above-mentioned area ratio A₄₄/A₁₃₂ is 5 or more and less than 10, which are determined by evolved gas analysis-mass spectrometry (EGA-MS) for the electrode. According to the electrode of the first embodiment, a battery with excellent life performance can be provided.

### Second Embodiment

According to a second embodiment, a battery is provided. The battery includes a positive electrode, a negative electrode, and an electrolyte. At least one of the positive electrode or the negative electrode includes the electrode according to the first embodiment. The battery may further include a separator. The positive electrode, the negative electrode, and the separator may configure an electrode group. The electrolyte may be held in the electrode group. The battery may further include a container member that houses the electrode group and the electrolyte. The battery may further include a positive electrode terminal electrically connected to the positive electrode and a negative electrode terminal electrically connected to the negative electrode. At least a part of the positive electrode terminal and at least a part of the negative electrode terminal may extend outside the container member.

The battery may be, for example, a lithium ion secondary battery. The battery also includes, for example, a nonaqueous electrolyte battery containing a nonaqueous electrolyte as the electrolyte.

Hereinafter, the negative electrode, positive electrode, electrolyte, separator, container member, positive electrode terminal, and negative electrode terminal will be described in detail. The following example is an example in which the electrode of the first embodiment is applied to the positive electrode.

### (1) Positive Electrode

The positive electrode includes a positive electrode current collector and a positive electrode active material-containing layer (positive electrode mixture layer) supported on one surface or both the obverse and reverse surfaces of the positive electrode current collector and containing a positive electrode active material, an electro-conductive agent, and a binder.

The positive electrode may be the electrode according to the first embodiment. In an aspect as the positive electrode, the positive electrode current collector, the positive electrode active material, and the positive electrode active material-containing layer of the positive electrode respectively correspond to the current collector, the active material-containing substance, and the mixture layer of the electrode according to the first embodiment. Since the electrode according to the first embodiment has been described above, the description of the positive electrode here is omitted.

### (2) Negative Electrode

The negative electrode includes a negative electrode current collector and a negative electrode active material-containing layer (negative electrode mixture layer) supported on one surface or both the obverse and reverse surfaces of the negative electrode current collector and containing a negative electrode active material. The negative electrode active material-containing layer may contain an electro-conductive agent and a binder, in addition to the negative electrode active material.

Hereinafter, the negative electrode active material, the electro-conductive agent, the binder, and the negative electrode current collector will be described.

Examples of the negative electrode active material include titanium-containing oxides, carbonaceous materials, and metal compounds. The species of the negative electrode active material may be one species or two species or more.

Examples of the titanium-containing oxides include titanium dioxide, a lithium-titanium oxide, a metal composite oxide containing Ti and at least one element selected from the group consisting of P, V, Sn, Cu, Ni, and Fe, and a niobium-titanium oxide. Examples of the lithium-titanium oxide include a lithium-titanium oxide having a spinel type crystal structure, and ramsdellite type Li₂₊ₓTi₃O₇ (x varies in a range of −1≤x≤3 through charge and discharge reactions). Examples of the metal composite oxide containing Ti and at least one element selected from the group consisting of P, V, Sn, Cu, Ni, and Fe include TiO₂—P₂O₅, TiO₂—V₂O₅, TiO₂—P₂O₅—SnO₂, and TiO₂—P₂O₅-MO (M is at least one element selected from the group consisting of Cu, Ni and Fe). Examples of the niobium-titanium oxide include a niobium-titanium oxide having a composition represented by the general formula LiₘTi₁₋ₙM3ₙNb₂₋ₗM4ₗO_{7+σ} (M3 is at least one element selected from the group consisting of Zr, Si, Sn, Fe, Co, Mn, and Ni, M4 is at least one element selected from the group consisting of V, Nb, Ta, Mo, W, and Bi, 0 5≤m≤5, 0≤n<1, 0≤l<2, and −0.3≤σ«0.3) and having a monoclinic crystal structure, Ti₂Nb₁₀O₁₉, and the like. The metal composite oxide contains lithium upon having lithium being inserted through charging.

The titanium-containing oxide preferably includes a lithium-titanium oxide. An electrode containing a titanium-containing oxide such as a lithium-titanium oxide can exhibit a Li insertion potential of 0.4 V (vs. Li/Li⁺) or more in terms of a value relative to an oxidation-reduction potential of lithium. Therefore, even when input and output with a large current are repeated, precipitation of metallic lithium on the electrode surface can be prevented. In addition, the lithium-titanium oxide has lower input resistance as compared to that of the niobium-titanium oxide. Furthermore, since the reaction potential based on Li is higher (on the noble side) than that of the niobium-titanium oxide, a side reaction with the electrolyte hardly occurs, and the resistance increase rate tends to be low. The lithium-titanium oxide particularly preferably includes a lithium-titanium oxide having a spinel type crystal structure. A specific example of such a spinel type lithium-titanium oxide is, lithium titanate having a spinel structure represented by Li₄₊ₐTi₅O₁₂, where the value of the subscript a changes within a range of 0≤a≤3 through charging and discharging.

The carbonaceous material is, for example, natural graphite, artificial graphite, coke, vapor-grown carbon fibers, mesophase pitch-based carbon fibers, spherical carbon, or resin-fired carbon. More preferable examples of the carbonaceous material include vapor-grown carbon fibers, mesophase pitch-based carbon fibers, and spherical carbon. The carbonaceous material preferably has a (002) plane with a lattice spacing door of 0.34 nm or less according to X-ray diffraction.

As the metal compound, a metal sulfide or a metal nitride can be used. As the metal sulfide, for example, titanium sulfide such as TiS₂, for example, molybdenum sulfide such as MoS₂, and for example, iron sulfide such as Fes, FeS₂, or LiᵥFeS₂ (0.9≤v≤1.2) can be used. As the metal nitride, lithium cobalt nitride (for example, LiₛCoₜN; 0<s<4 and 0<t<0.5) can be used.

The active material may have a particulate form. Examples of the active material particles may include active material primary particles and active material secondary particles. The secondary particles are formed by aggregation of the primary particles.

The secondary particles preferably have an average particle size (average secondary particle size) of 1 μm or more and 100 μm or less. When the average particle size of the secondary particles is within this range, they can be handled well in industrial production, and the mass and thickness can be made uniform in a coating film for producing the electrode. Furthermore, deterioration in surface smoothness of the electrode can be prevented. The average particle size of the secondary particles is more preferably 2 μm or more and 30 μm or less.

The specific surface area of the secondary particles as measured by a BET method is preferably 3 m²/g or more and 50 m²/g or less. When the specific surface area is 3 m²/g or more, insertion/extraction sites of lithium ions can be sufficiently secured. When the specific surface area is 50 m²/g or less, the secondary particles are easy to handle in industrial production. More preferably, the secondary particles have a specific surface area of 5 m²/g or more and 50 m²/g or less as measured by the BET method.

The electro-conductive agent can have an action of enhancing current collection performance and suppressing contact resistance between the active material and the current collector. Examples of the electro-conductive agent include carbonaceous materials such as acetylene black, carbon black, graphite, carbon nanofibers, and carbon nanotubes. These carbonaceous materials may be used alone, or a plurality of the carbonaceous substances may be used.

The binder can have an action of binding the negative electrode active material particles, the electro-conductive agent, and the current collector. Examples of the binder include polytetrafluoroethylene (PTFE), polyvinylidene fluoride (PVdF), carboxylated PVdF, fluororubber, styrene butadiene rubber, acrylic resin and copolymers thereof, polyacrylic acid, and polyacrylonitrile. The species of the binder may be one species or two species or more.

Blending ratios of the negative electrode active material, the electro-conductive agent, and the binder are preferably in a range of 70 mass % or more and 97.5 mass % or less for the negative electrode active material, 2 mass % or more and 20 mass % or less for the electro-conductive agent, and 0.5 mass % or more and 10 mass % or less for the binder, respectively. The amount of the electro-conductive agent is set to 2 mass % or more, so that the current collection performance of the active material-containing layer can be improved, and excellent large current performance and low temperature performance can be expected. The amount of the binder is set to 0.5 mass % or more, so that binding between the active material-containing layer and the current collector is sufficient, whereby excellent high temperature storage performance can be expected. On the other hand, from the viewpoint of increasing the capacity, the amount of the electro-conductive agent is preferably 20 mass % or less, and the content of the binder is preferably 10 mass % or less.

When the negative electrode active material is a material capable of having lithium ions inserted and extracted, a material electrochemically stable at the lithium ion insertion and extraction potential of the negative electrode active material can be used as the negative electrode current collector. The negative electrode current collector is preferably a metal foil made of at least one selected from copper, nickel, stainless steel, and aluminum, or an alloy foil made of an aluminum alloy containing at least one element selected from Mg, Ti, Zn, Mn, Fe, Cu, and Si. As the shape of the negative electrode current collector, various shapes can be used in accordance with the application of the battery. A thickness of the current collector can be, for example, 20 μm or less, or 15 μm or less.

The negative electrode can be produced by, for example, the following method. First, the negative electrode active material, the binder, and, if necessary, the electro-conductive agent are suspended in a commonly used solvent such as N-methylpyrrolidone to prepare a slurry for producing a negative electrode. The obtained slurry is applied onto the negative electrode current collector. The applied slurry is dried, and the coating film obtained after drying is pressed, to thereby obtain a negative electrode including a negative electrode current collector and a negative electrode active material-containing layer formed on the negative electrode current collector.

### (3) Electrolyte

Examples of the electrolyte include a nonaqueous electrolyte. Examples of the nonaqueous electrolyte include a liquid nonaqueous electrolyte (nonaqueous electrolytic solution) prepared by dissolving an electrolyte salt (solute) in a nonaqueous solvent, and a gel nonaqueous electrolyte obtained by combining a liquid nonaqueous electrolyte and a polymer material into a composite.

Examples of the electrolyte salt include lithium salts such as lithium perchlorate (LiClO₄), lithium hexafluorophosphate (LiPF₆), lithium tetrafluoroborate (LiBF₄), lithium arsenic hexafluoride (LiAsF₆), lithium difluorophosphate (LiPO₂F₂), lithium trifluoromethanesulfonate (LiCF₃SO₃), and lithium bistrifluoromethylsulfonylimide [LiN(CF₃SO₂)₂]. These electrolyte salts may be used alone or as a mixture of two species or more thereof.

The electrolyte salt is preferably dissolved in a nonaqueous solvent in a range of 0.5 mol/L or more and 2.5 mol/L or less.

Examples of the nonaqueous solvent include organic solvents such as cyclic carbonates such as ethylene carbonate (EC), propylene carbonate (PC), and vinylene carbonate (VC); linear carbonates such as dimethyl carbonate (DMC), ethyl methyl carbonate (EMC), and diethyl carbonate (DEC); cyclic ethers such as tetrahydrofuran (THF) and 2-methyl tetrahydrofuran (2MeTHF); linear ethers such as dimethoxyethane (DME); cyclic esters such as γ-butyrolactone (BL); linear esters such as methyl acetate, ethyl acetate, methyl propionate, and ethyl propionate; acetonitrile (AN); and sulfolane (SL). These organic solvents may be used alone or in the form of a mixture of two species or more.

Examples of the polymeric material used in the gel nonaqueous electrolyte include polyvinylidene fluoride (PVdF), polyacrylonitrile (PAN), and polyethylene oxide (PEO).

### (4) Separator

The separator may be disposed, for example, on at least one of the positive electrode or the negative electrode, or between the positive electrode and the negative electrode.

The separator may be, for example, a porous film, synthetic resin nonwoven fabric, or the like including polyethylene (PE), polypropylene (PP), cellulose, or polyvinylidene fluoride (PVdF).

### (5) Container Member

The container member may be formed of a laminate film or a metal container. When a metal container is used, a lid can be integrated with or be separate from the container. A thickness of the metal container is more preferably 0.5 mm or less or 0.2 mm or less. Examples of the shape of the container member include a flat type, a rectangular type, a cylindrical type, a coin type, a button type, a sheet type, and a stacked type. The container member may be a container member for a small battery installed in a portable electronic device or the like, or may be a container member for a large battery installed in a two-wheeled to four-wheeled automobile.

A thickness of the laminate film container member is desirably 0.2 mm or less. Examples of the laminate film include a multilayer film including a resin film and a metal layer disposed between the resin films. The metal layer is preferably an aluminum foil or an aluminum alloy foil, in order to reduce weight. The resin film may be, for example, a polymer material such as polypropylene (PP), polyethylene (PE), nylon, or polyethylene terephthalate (PET). The laminate film can be formed into a shape of a container member by performing sealing through thermal fusion.

The metal container is made of aluminum, an aluminum alloy, or the like. The aluminum alloy is preferably an alloy containing an element such as magnesium, zinc, or silicon. In aluminum or an aluminum alloy, the content of the transition metal such as iron, copper, nickel, or chromium is preferably 100 ppm or less in order to dramatically improve long-term reliability and heat dissipation under a high-temperature environment.

The metal container made of aluminum or an aluminum alloy desirably has an average crystal grain size of 50 μm or less, more preferably 30 μm or less, and even more preferably 5 μm or less. By setting the average crystal grain size to 50 μm or less, the strength of the metal container made of aluminum or an aluminum alloy can be dramatically increased, and the container can be made even thinner. As a result, a battery that is lightweight, has high output, and is excellent in long-term reliability can be realized, which is suitable for onboard application and the like.

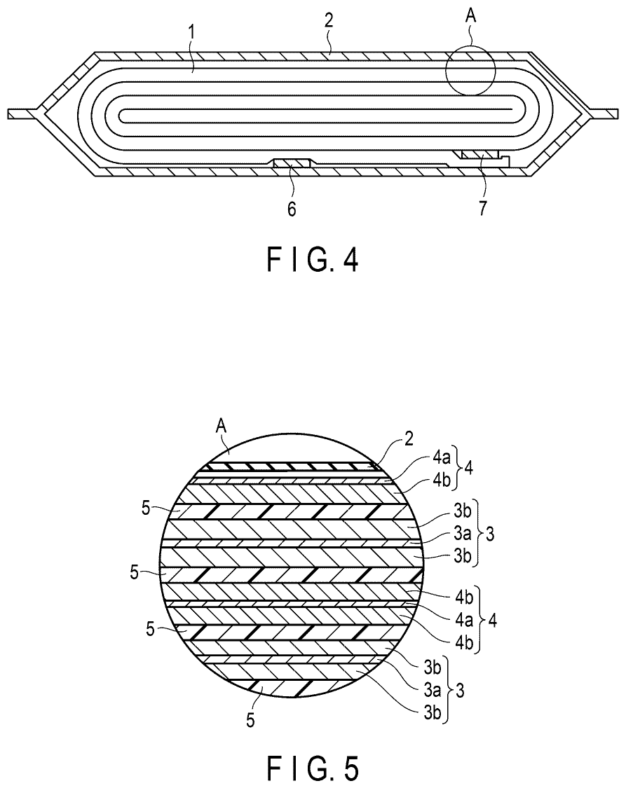

An example of the battery will be described with reference to FIGS. 4 and 5. The flat-type battery illustrated in FIG. 4 includes a flat-shaped wound electrode group 1, a container member 2, a positive electrode terminal 7, a negative electrode terminal 6, and an electrolyte (not illustrated). The container member 2 is a bag-shaped container member made of a laminate film. The wound electrode group 1 is housed in the container member 2. As illustrated in FIG. 5, the wound electrode group 1 includes a positive electrode 3, a negative electrode 4, and a separator 5, and is formed by spirally winding and press-molding a stack in which the negative electrode 4, the separator 5, the positive electrode 3, and the separator 5 are stacked in this order from the outside.

The positive electrode 3 includes a positive electrode current collector 3a and a positive electrode active material-containing layer 3b. The positive electrode active material-containing layer 3b contains a positive electrode active material. The positive electrode active material-containing layer 3b is formed on both surfaces of the positive electrode current collector 3a. The negative electrode 4 includes a negative electrode current collector 4a and a negative electrode active material-containing layer 4b. The negative electrode active material-containing layer 4b contains a negative electrode active material. In a portion of the negative electrode 4 located on the outermost side, the negative electrode active material-containing layer 4b is formed only on one surface on an inner surface side of the negative electrode current collector 4a. For the other portions of the negative electrode 4, the negative electrode active material-containing layers 4b are formed on both surfaces of the negative electrode current collector 4a.

As illustrated in FIG. 4, the positive electrode terminal 7 is electrically connected to the positive electrode 3 in the vicinity of the outer peripheral end of the wound electrode group 1. In addition, the negative electrode terminal 6 is electrically connected to the negative electrode 4 in the outermost portion. The positive electrode terminal 7 and the negative electrode terminal 6 extend outside through an opening of the container member 2.

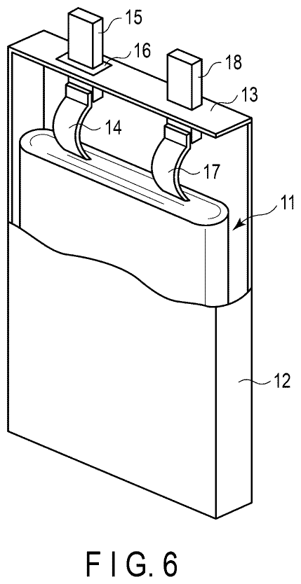

The battery is not limited to those having the configuration as illustrated in FIGS. 4 and 5 described above, and may have, for example, the configuration illustrated in FIG. 6.

In the prismatic battery illustrated in FIG. 6, the wound electrode group 11 is housed in a bottomed prismatic cylindrical container 12 made of metal as a container member. A rectangular lid body 13 is welded to an opening of the container 12. The flat wound electrode group 11 can have, for example, the same configuration as the wound electrode group 1 described with reference to FIGS. 4 and 5.

One end of a negative electrode tab 14 is electrically connected to the negative electrode current collector, and the other end thereof is electrically connected to a negative electrode terminal 15. The negative electrode terminal 15 is fixed to the rectangular lid body 13 by hermetic sealing with a glass material 16 interposed therebetween. One end of a positive electrode tab 17 is electrically connected to the positive electrode current collector, and the other end thereof is electrically connected to the positive electrode terminal 18 fixed to the rectangular lid body 13.

The negative electrode tab 14 is made of, for example, a material such as aluminum or an aluminum alloy containing an element such as Mg, Ti, Zn, Mn, Fe, Cu, or Si. The negative electrode tab 14 is preferably made of the same material as the negative electrode current collector, in order to reduce contact resistance between the negative electrode tab and the negative electrode current collector.

The positive electrode tab 17 is made of, for example, a material such as aluminum or an aluminum alloy containing an element such as Mg, Ti, Zn, Mn, Fe, Cu, or Si. The positive electrode tab 17 is preferably made of the same material as the positive electrode current collector, in order to reduce contact resistance between the positive electrode tab and the positive electrode current collector.

In the illustrated battery, the wound electrode group in which the separator is wound together with the positive electrode and the negative electrode is used, but a stacked electrode group in which the separator is folded zigzag and the positive electrode and the negative electrode are alternately disposed at the folded portions may be used, as well.

The battery of the second embodiment described above includes the electrode of the first embodiment as at least one of the positive electrode or the negative electrode. Therefore, the battery of the second embodiment is excellent in life performance.

### Third Embodiment

According to a third embodiment, a battery pack is provided. The battery pack includes the electrode of the first embodiment or the battery according to the second embodiment.

The battery pack according to the third embodiment can include one or more batteries (single-batteries) according to the second embodiment described above. The plurality of batteries that can be included in the battery pack can be electrically connected to each other in series or in parallel to form a battery module. The battery pack may include a plurality of battery modules.

Next, an example of the battery pack according to the third embodiment will be described with reference to the drawings.

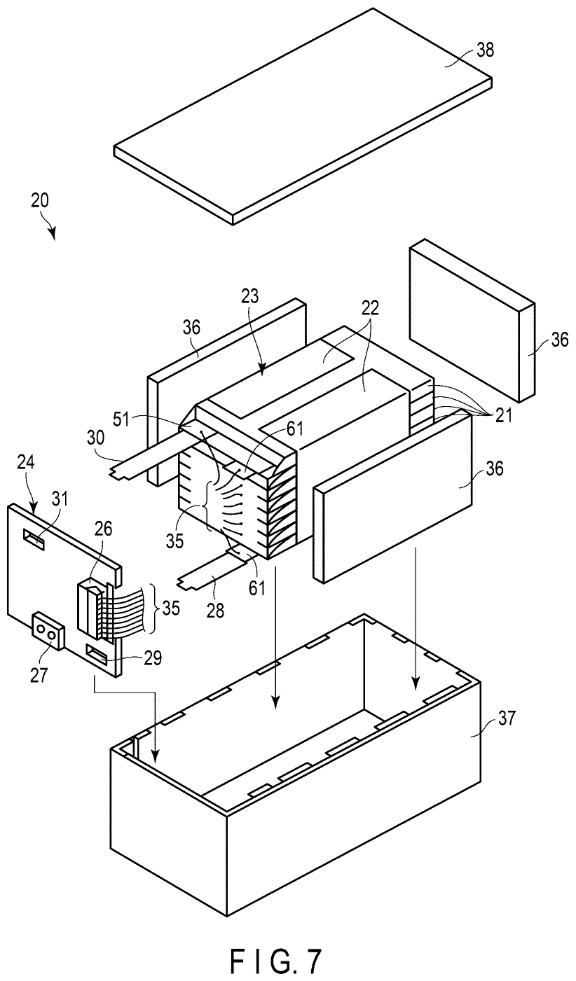

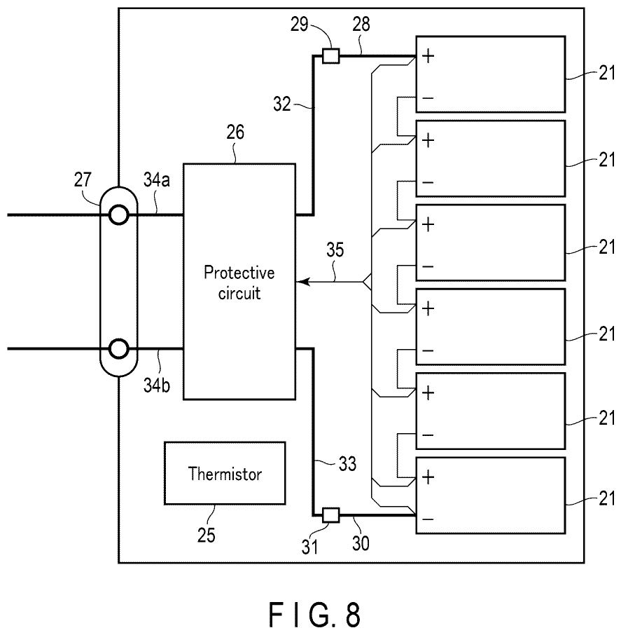

FIG. 7 is an exploded perspective view of an example of the battery pack according to the embodiment. FIG. 8 is a block diagram illustrating an electric circuit of the battery pack of FIG. 7.

A battery pack 20 illustrated in FIGS. 7 and 8 includes a plurality of single batteries 21. The single-battery 21 may be an example of a flat battery according to the embodiment described with reference to FIG. 4.

The plurality of single-batteries 21 are stacked so that a negative electrode terminal 51 and a positive electrode terminal 61 extending outside are aligned in the same direction, and are fastened with an adhesive tape 22 to configure a battery module 23. These single-batteries 21 are electrically connected to each other in series, as illustrated in FIG. 8.

A printed wiring board 24 is disposed to face a side surface from which the negative electrode terminal 51 and the positive electrode terminal 61 of the single batteries 21 extend. As illustrated in FIG. 8, a thermistor 25, a protective circuit 26, and a power distribution terminal 27 to an external device are mounted on the printed wiring board 24. An insulating plate (not illustrated) is attached to the printed wiring board 24 on a surface facing the battery module 23 in order to avoid unnecessary connection with a wiring of the battery module 23.

A positive electrode-side lead 28 is connected to the positive electrode terminal 61 located lowermost in the battery module 23, and a tip thereof is inserted into and electrically connected to a positive electrode-side connector 29 of the printed wiring board 24. A negative electrode-side lead 30 is connected to the negative electrode terminal 51 located uppermost in the battery module 23, and a tip thereof is inserted into and electrically connected to a negative electrode-side connector 31 of the printed wiring board 24. These connectors 29 and 31 are connected to the protective circuit 26 through wirings 32 and 33 formed on the printed wiring board 24.

The thermistor 25 detects the temperature of the single-batteries 21 and transmits detection signals to the protective circuit 26. The protective circuit 26 can cut off a plus-side wiring 34a and a minus-side wiring 34b between the protective circuit 26 and the power distribution terminal 27 to an external device under a predetermined condition. An example of the predetermined condition is, for example, when the temperature detected by the thermistor 25 becomes equal to or higher than a predetermined temperature. Another example of the predetermined condition is, for example, when over-charge, over-discharge, over-current, or the like of the single-batteries 21 is detected. The detection of the over-charge or the like is performed on each of the single-batteries 21 or the entire battery module 23. In a case where each of the single-batteries 21 is detected, the battery voltage may be detected, or a positive electrode potential or negative electrode potential may be detected. In the latter case, a lithium electrode to be used as a reference electrode is inserted into each of the single-batteries 21. In the case of the battery pack 20 in FIGS. 7 and 8, a wiring 35 for voltage detection is connected to each of the single batteries 21. Detection signals are transmitted to the protective circuit 26 through these wirings 35.

Protective sheets 36 made of rubber or resin are disposed on three side surfaces of the battery module 23 except for the side surface from which the positive electrode terminal 61 and the negative electrode terminal 51 protrude.

The battery module 23 is housed in a housing container 37 together with each of the protective sheets 36 and the printed wiring board 24. That is, the protective sheet 36 is disposed on each of both inner side surfaces in the long side direction and an inner side surface in the short side direction of the housing container 37, and the printed wiring board 24 is disposed on the inner side surface on the opposite side in the short side direction. The battery module 23 is located in a space surrounded by the protective sheets 36 and the printed wiring board 24. A lid 38 is attached to an upper surface of the housing container 37.

For fixing the battery module 23, a heat-shrinkable tape may be used instead of the adhesive tape 22. In this case, the protective sheets are disposed on both side surfaces of the battery module, and the heat shrinkable tape is wound around the battery module and protective sheets. Thereafter, the heat shrinkable tape is shrunk by heating to bundle the single-batteries.

FIGS. 7 and 8 illustrate the form in which the single-batteries 21 are connected in series, but the single-batteries may be connected in parallel in order to increase the battery capacity. Further, the assembled battery packs can be connected in series and/or in parallel.

In addition, a mode of the battery pack is appropriately changed depending on the application thereof. The application of the battery pack is preferably one in which good cycle performance is desired when a large current discharge is performed. Specific applications include power source applications for a digital camera, and in-vehicle applications for a two-wheeled to four-wheeled hybrid electric vehicle, a two-wheeled to four-wheeled electric vehicle, and a power-assisted bicycle. The battery pack is particularly suitably used in onboard applications.

The battery pack according to the third embodiment includes the electrode according to the first embodiment or the battery according to the second embodiment. Therefore, the battery pack can exhibit excellent life performance.

### EXAMPLES

The present invention will be described in more detail with reference to examples described below, but is not limited to the examples listed below, as long as it does not depart from the spirit of the invention.

### Example 1

### <Production of Positive Electrode>

A lithium nickel cobalt manganese-containing oxide (LiNi_{0.8}Co_{0.1}Mn_{0.1}O₂) containing an alkali component in a proportion of 0.5 mass % was provided as a positive electrode active material-containing substance. The alkali component included Li₂CO₃ and LiOH. The breaking strength, average particle size D₅₀, and D₉₀/D₁₀ of the positive electrode active material-containing substance were measured by the above-described methods, and the results are shown in Table 1.

In addition, carbon black (CB) was provided as an electro-conductive agent. Then, polyvinylidene fluoride (PVdF) as a binder and a dispersant were provided. As the dispersant, a polymer containing a nitrile group-containing monomer unit and an alkylene structural unit was prepared by subjecting a precursor, which was obtained by copolymerizing acrylonitrile and 1,3-butadiene, to a hydrogenation reaction. Next, CB was dispersed in n-methylpyrrolidone (NMP) and the prepared dispersant was added and further dispersed to obtain a CB dispersion liquid. At this time, CB was added so as to attain a proportion of 5 mass % with respect to a positive electrode mixture layer (positive electrode active material-containing layer) to be produced, and the dispersant was added so as to attain a proportion of 5 mass % with respect to CB. Next, PVdF was added to and dispersed in the CB dispersion liquid, and then the positive electrode active material was added and dispersed therein to prepare a slurry. At this time, PVdF was added so as to attain 2 mass % with respect to the positive electrode mixture layer (positive electrode active material-containing layer) to be produced. The obtained slurry was applied onto an aluminum foil having a thickness of 12 μm so that an amount of the applied slurry per unit area was 80 g/m², and dried. The dried coating film was then pressed. In this way, positive electrodes each having a positive electrode mixture layer with a basis weight of 80 g/m² and a density of 3.3 g/cm³ were produced.

### <Production of Negative Electrode>

As a negative electrode active material, a lithium-titanium oxide having a spinel type crystal structure (Li₄Ti₅O₁₂) was provided. In addition, graphite was provided as an electro-conductive agent. PVdF was provided as a binder. Next, the negative electrode active material, carbon black, and PVdF were mixed to obtain a mixture. At this time, carbon black was added so as to attain 4 mass % with respect to a negative electrode mixture layer (negative electrode active material-containing layer) to be produced. PVdF was added so as to attain 2 mass % with respect to the negative electrode mixture layer (negative electrode active material-containing layer) to be produced. Next, the obtained mixture was mixed in an N-methylpyrrolidone (NMP) solution to prepare a slurry. The obtained slurry was applied onto a current collector made of an aluminum foil having a thickness of 12 μm, such that the applied amount per unit area was 101 g/m², and dried. Subsequently, the dried coating film was pressed to form a negative electrode mixture layer on the current collector. In this way, band-shaped negative electrodes each having a negative electrode mixture layer with a basis weight of 100 g/m² and a density of 2.1 g/cm³ were produced.

### <Preparation of Nonaqueous Electrolyte>

A liquid nonaqueous electrolyte containing 14 vol % of LiPF₆, 33 vol % of propylene carbonate (PC), and 53 vol % of diethyl carbonate (DEC) was prepared.

### <Production of Electrode Group>

A stacked electrode group in which the separator was folded zigzag, and the positive electrodes and the negative electrodes were alternately arranged at the folded portions was produced. The obtained electrode group was housed in a pack (container member) made of a laminate film having a thickness of 0.1 mm, and vacuum-dried at 95° C. for 10 hours.

### <Production of Nonaqueous Electrolyte Battery>

The liquid nonaqueous electrolyte was put into the laminate film pack housing the electrode group, and then the pack was completely sealed by heat-sealing to produce a nonaqueous electrolyte battery having a rated capacity of 1 Ah.

### Example 2

A nonaqueous electrolyte battery was produced in the same manner as in Example 1, except that the addition amount of the dispersant was changed to 3 mass % with respect to CB.

### Example 3

A nonaqueous electrolyte battery was produced in the same manner as in Example 1, except that the addition amount of the dispersant was changed to 10 mass % with respect to CB.

### Example 4

A nonaqueous electrolyte battery was produced in the same manner as in Example 1, except that as the positive electrode active material-containing substance, a lithium nickel cobalt manganese-containing oxide containing residual alkali component in a content of 0.4 mass % was used instead.

### Example 5

A nonaqueous electrolyte battery was produced in the same manner as in Example 1, except that as the positive electrode active material-containing substance, a lithium nickel cobalt manganese-containing oxide containing residual alkali component in a content of 1 mass % was used instead.

### Comparative Example 1

A nonaqueous electrolyte battery was produced in the same manner as in Example 1, except that the positive electrode was produced by preparing a slurry without using a dispersant, as described below.

A lithium nickel cobalt manganese-containing oxide (LiNi_{0.8}Co_{0.1}Mn_{0.1}O₂) containing alkali component in a proportion of 0.5 mass % was provided as the positive electrode active material-containing substance. CB was provided as the electro-conductive agent. PVdF was provided as the binder. Next, the positive electrode active material and CB were mixed to obtain a mixture. At this time, CB was added so as to attain a proportion of 5 mass % with respect to a positive electrode mixture layer to be produced. Next, the obtained mixture was dispersed in a mixed solvent of NMP and PVdF to prepare a slurry. At this time, PVdF was added so as to attain 2 mass % with respect to the positive electrode mixture layer to be produced. Thereafter, the positive electrode was prepared in the same manner as in Example 1.

Furthermore, the negative electrode, the nonaqueous electrolyte, the electrode group, and the nonaqueous electrolyte battery were prepared in the same manner as in Example 1.

### Comparative Example 2

A nonaqueous electrolyte battery was produced in the same manner as in Example 1, except that the addition amount of the dispersant was changed to 30 mass % with respect to CB.

### Comparative Example 3

A nonaqueous electrolyte battery was produced in the same manner as in Example 1, except that as the positive electrode active material-containing substance, a lithium nickel cobalt manganese-containing oxide containing residual alkali component in a content of 0.3 mass % was used instead.

### Comparative Example 4

A nonaqueous electrolyte battery was produced in the same manner as in Example 1, except that as the positive electrode active material-containing substance, a lithium nickel cobalt manganese-containing oxide containing residual alkali component in a content of 1.2 mass % was used instead.

Table 1 shows the amount of alkali component contained in the positive electrode active material-containing substance, the breaking strength of the positive electrode active material, the average particle size D₅₀, D₉₀/D₁₀, and the amount of dispersant added to the positive electrode production slurry for each of Examples 1 to 5 and Comparative Examples 1 to 4.

TABLE 1

| | Alkali | | | | |
|---|---|---|---|---|---|
| | Component | | | | |
| | Amount in | | Positive | | |
| | Positive | Positive | Electrode | | Dispersant |
| | Electrode | Electrode | Active | | Addition |
| | Active | Active | Material | | Amount/ |
| | Material- | Material | Average | | Mass % |
| | Containing | Breaking | Particle | | (relative |
| | Substance/ | Strength/ | Diameter | | to CB |
| | Mass % | MPa | D₅₀/ μm | D₉₀/D₁₀ | amount) |
| Example 1 | 0.5 | 173.5 | 4.1 | 3.3 | 5 |
| Example 2 | 0.5 | 173.5 | 4.1 | 3.3 | 3 |
| Example 3 | 0.5 | 173.5 | 4.1 | 3.3 | 10 |
| Example 4 | 0.4 | 152.9 | 5.8 | 2.8 | 5 |
| Example 5 | 1 | 203.4 | 5.1 | 3.1 | 5 |
| Comparative | 0.5 | 173.5 | 4.1 | 3.3 | 0 |
| Example 1 | | | | | |
| Comparative | 0.5 | 173.5 | 4.1 | 3.3 | 30 |
| Example 2 | | | | | |
| Comparative | 0.3 | 51.8 | 6.2 | 4.2 | 5 |
| Example 3 | | | | | |
| Comparative | 1.2 | 50.4 | 13.4 | 8.2 | 5 |
| Example 4 | | | | | |

The positive electrode produced in each example was subjected to measurement by evolved gas analysis-mass spectrometry (EGA-MS). In the obtained spectrum, the curve derived from the component of m/z=132 and the curve derived from the component of m/z=44 were obtained, and the peak kurtosis (ratio I_{AVE}/I_{TOP}) of the highest intensity peak in the m/z=132 curve and the ratio A₄₄/A₁₃₂ of the area on the high temperature side of the m/z=44 curve to the area on the low temperature side of the m/z=132 curve were obtained. The nonaqueous electrolyte battery of each example was subjected to life evaluation by the following method. The results thereof are shown in Table 2.

Charging and discharging were performed in the range of SOC 0% to SOC 100% under conditions of the charging rate 3C, the discharging rate 3C, and the environmental temperature of 75° C. In the charging and discharging, the battery was first charged to SOC 100%, and then discharged to SOC 0%. This was defined as one charge-and-discharge cycle, and the initial discharge capacity was measured. This charge-and-discharge cycle was repeated 300 times, and the discharge capacity after 300 cycles was measured. Then, the capacity retention ratio after 300 cycles was evaluated as a percentage by dividing the discharge capacity after 300 cycles by the initial discharge capacity and multiplying the result by 100. Moreover, the battery was sealed inside a container having an interior in a vacuum state, then the laminate film pack was opened, and the amount of gas that flowed out was measured.

TABLE 2

| | EGA-MS | | Life Performance | |
|---|---|---|---|---|
| | Peak | EGA-MS | Evaluation | |
| | Kurtosis | Area | Gas | Capacity |
| | I_{AVE}/I_{TOP} | Ratio | Generation | Retention |
| | (m/z = 132) | A₄₄/A₁₃₂ | Amount/ cc | Ratio/ % |
| Example 1 | 0.3 | 6.4 | 1.5 | 93.6 |
| Example 2 | 0.41 | 5.7 | 2 | 92.8 |
| Example 3 | 0.24 | 7.2 | 1.4 | 92.6 |
| Example 4 | 0.27 | 5.9 | 2.1 | 93.2 |
| Example 5 | 0.43 | 8.7 | 2.1 | 91.6 |
| Comparative | 0.58 | 4.2 | 2.3 | 91.3 |
| Example 1 | | | | |
| Comparative | 0.14 | 9.7 | 1.4 | 89.8 |
| Example 2 | | | | |
| Comparative | 0.27 | 3.6 | 2.7 | 91.1 |
| Example 3 | | | | |
| Comparative | 0.45 | 13 | 2.8 | 90.3 |
| Example 4 | | | | |

As is clear from Table 2, for the nonaqueous electrolyte batteries of Examples 1 to 5, either of the life performance evaluation results was better as compared with the batteries of Comparative Examples 1 to 4. Specifically, the nonaqueous electrolyte batteries of Examples 1 to 5 had a smaller amount of gas generated, a higher capacity retention ratio, or both.

For the positive electrode produced in Comparative Example 1, in the m/z=132 curve measured therefor by EGA-MS, a broad highest intensity peak having a high ratio I_{AVE}/I_{TOP} was obtained. This indicates that because of omission of addition of the dispersant to the positive electrode production slurry, PVdF was mainly bound to CB, resulting in the PVdF decomposition temperature having been lowered by the catalytic action. The highest intensity peak of m/z=132 was shifted to the low temperature side and became broad. Furthermore, the fact that binding of PVdF to the active material was small because of preferential binding of PVdF to CB is apparent through a small value of the ratio A₄₄/A₁₃₂. Due to little coating of the active material with PVdF, the amount of gas generated by the reaction between the electrolyte and the active material was large. Localized deterioration occurred due to the reaction unevenness in the positive electrode caused by aggregation of CB, and electro-conductive paths were impaired due to expansion and contraction of the active material, resulting in lowering of the capacity retention ratio.

For the positive electrode produced in Comparative Example 2, in the m/z=132 curve measured therefor, a sharp highest intensity peak having a low ratio I_{AVE}/I_{TOP} was obtained. This indicates that since the amount of the dispersant was excessive, CB was very well dispersed, resulting in little binding of PVdF to CB. Since the large amount of the dispersant as a resistance component was contained, the resistance was increased, and the capacity retention ratio was decreased.

For the positive electrode produced in Comparative Example 3, the value of the ratio A₄₄/A₁₃₂ obtained from the EGA-MS spectrum measured therefor was small, which indicates little binding of PVdF to the active material. Because the amount of the alkali component in the positive electrode active material-containing substance was small, which made binding by the binder poor, the amount of gas generated by the reaction between the electrolyte and the active material increased. In addition, electrically conductive paths within the positive electrode was impaired due to expansion and contraction of the active material, and the capacity retention ratio was lowered.

For the positive electrode produced in Comparative Example 4, the value of the ratio A₄₄/A₁₃₂ obtained from the EGA-MS spectrum measured therefor was large. This indicates that since the amount of the alkali component contained in the active material comprising-substance was large, the cross-linking reaction of the binder excessively proceeded, resulting in excessive binding of PVdF to the active material. Due to the excessive progress of the cross-linking reaction of the binder, hydrogen fluoride (HF) was excessively produced, and the amount of gas generated was increased. In addition, since the active material was excessively coated with PVdF, the resistance increased, and the capacity retention ratio decreased.

The inventions of the embodiments will be additionally described.

1. An electrode comprising:
an active material-containing substance containing an active material comprising a lithium nickel cobalt manganese-containing oxide; an electro-conductive agent; and a binder,
a ratio I_{AVE}/I_{TOP} of an average value I_{AVE} of a peak intensity at +20° C. from a peak top of a highest intensity peak in a m/z=132 curve according to evolved gas analysis-mass spectrometry to a peak top intensity I_{TOP} of the peak top being 0.2 or more and less than 0.5, and
a ratio A₄₄/A₁₃₂ of an area A₄₄ under a m/z=44 curve within a range of 550° C. to 600° C. according to evolved gas analysis-mass spectrometry to an area A₁₃₂ under the m/z=132 curve within a range of 200° C. to 550° C. being 5 or more and less than 10.

2. The electrode according to clause 1,
wherein the active material-containing substance comprises 0.4 mass % or more and 1 mass % or less of an alkali component comprising at least one of lithium carbonate or lithium hydroxide.

3. The electrode according to clause 1 or 2, wherein the lithium nickel cobalt manganese-containing oxide is represented by LiₐNi_{(1-b-c-d)}Co_{b}Mn_{c}M_{d}O₂, where 1≤a≤1.2, 0<b≤0.4, 0<c≤0.4, 0≤d≤0.1, and M is one or more elements selected from the group consisting of Fe, Cu, Ti, Mg, Al, W, Y, B, Mo, Nb, Zn, Sn, Zr, Ga, and V.

4. The electrode according to any one of clauses 1 to 3, wherein the binder comprises one or more selected from the group consisting of polyvinylidene fluoride and derivatives thereof.

5. The electrode according to any one of clauses 1 to 4, wherein the active material has a breaking strength of 30 MPa or more and 300 MPa or less.

6. The electrode according to any one of clauses 1 to 5, wherein the active material has a particle shape, and an average particle size of the active material according to a laser diffraction scattering method is 2 μm or more and 8 μm or less.

7. The electrode according to any one of clauses 1 to 6, wherein the active material has a particle shape, and a ratio D₉₀/D₁₀ in a volume-based cumulative frequency distribution of particle sizes based on a particle size distribution according to a laser diffraction scattering method of 4 or less, where D₁₀ is a particle size at which a cumulative frequency from a smaller particle size side of the cumulative frequency distribution is 10%, and D₉₀ is a particle size at which the cumulative frequency from the smaller particle size side of the cumulative frequency distribution is 90%.

8. The electrode according to any one of clauses 1 to 7, wherein the active material has a single-particle shape.

9. The electrode according to any one of clauses 1 to 8, wherein the electrode has a density of 3.1 g/cm³ or more and 3.5 g/cm³ or less.

10. A battery comprising:
a positive electrode comprising the electrode according to any one of clauses 1 to 9; and
a negative electrode.

11. The battery according to clause 10, wherein the negative electrode comprises a titanium-containing oxide.

12. The battery according to clause 11, wherein the titanium-containing oxide comprises at least one selected from the group consisting of a lithium-titanium oxide having a spinel crystal structure, a lithium-titanium oxide having a ramsdellite crystal structure, a niobium-titanium oxide, and titanium dioxide.

13. The battery according to any one of clauses 10 to 12, further comprising a nonaqueous electrolyte.

14. A battery pack comprising the battery according to any one of clauses 10 to 13.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An electrode comprising:
an active material-containing substance containing an active material comprising a lithium nickel cobalt manganese-containing oxide; an electro-conductive agent;
and a binder,
a ratio I_{AVE}/I_{TOP} Of an average value I_{AVE} of a peak intensity at +20° C. from a peak top of a highest intensity peak in a m/z=132 curve according to evolved gas analysis-mass spectrometry to a peak top intensity I_{TOP} of the peak top being 0.2 or more and less than 0.5, and
a ratio A₄₄/A₁₃₂ of an area A₄₄ under a m/z=44 curve within a range of 550° C. to 600° C. according to evolved gas analysis-mass spectrometry to an area A₁₃₂ under the m/z=132 curve within a range of 200° C. to 550° C. being 5 or more and less than 10.

2. The electrode according to claim 1,
wherein the active material-containing substance comprises 0.4 mass % or more and 1 mass % or less of an alkali component comprising at least one of lithium carbonate and lithium hydroxide.

3. The electrode according to claim 1, wherein the lithium nickel cobalt manganese-containing oxide is represented by LiₐNi_{(1-b-c-d)}Co_{b}Mn_{c}M_{d}O₂, where 1≤a≤1.2, 0<b≤0.4, 0<c≤0.4, 0≤d≤0.1, and M is one or more elements selected from the group consisting of Fe, Cu, Ti, Mg, Al, W, Y, B, Mo, Nb, Zn, Sn, Zr, Ga, and V.

4. The electrode according to claim 1, wherein the binder comprises one or more selected from the group consisting of polyvinylidene fluoride and derivatives thereof.

5. The electrode according to claim 1, wherein the active material has a breaking strength of 30 MPa or more and 300 MPa or less.

6. The electrode according to claim 1, wherein the active material has a particle shape, and an average particle size of the active material according to a laser diffraction scattering method is 2 μm or more and 8 μm or less.

7. The electrode according to claim 1, wherein the active material has a particle shape, and a ratio D₉₀/D₁₀ in a volume-based cumulative frequency distribution of particle sizes based on a particle size distribution according to a laser diffraction scattering method of 4 or less, where D₁₀ is a particle size at which a cumulative frequency from a smaller particle size side of the cumulative frequency distribution is 10%, and D₉₀ is a particle size at which the cumulative frequency from the smaller particle size side of the cumulative frequency distribution is 90%.

8. The electrode according to claim 1, wherein the active material has a single-particle shape.

9. The electrode according to claim 1, wherein the electrode has a density of 3.1 g/cm³ or more and 3.5 g/cm³ or less.

10. A battery comprising:
a positive electrode comprising the electrode according to claim 1; and
a negative electrode.

11. The battery according to claim 10, wherein the negative electrode comprises a titanium-containing oxide.

12. The battery according to claim 11, wherein the titanium-containing oxide comprises at least one selected from the group consisting of a lithium-titanium oxide having a spinel crystal structure, a lithium-titanium oxide having a ramsdellite crystal structure, a niobium-titanium oxide, and titanium dioxide.

13. The battery according to claim 10, further comprising a nonaqueous electrolyte.

14. A battery pack comprising the battery according to claim 10.
